(19) United States
(12) Patent Application Publication
(10) Pub. No.: US 2005/0178045 A1
(43) Pub. Date: Aug. 18, 2005

(54) Holder for a fish handling tool/scale

(76) Inventor: Charles F. Sleeper, St. Augustine, FL (US)

Correspondence Address: Mark J. Young, Suite 227, 9951 Atlantic Blvd., Jacksonville, FL, 32225, US

(21) Appl. No.: 10/996,232

(22) Filed: Nov. 23, 2004

Related U.S. Application Data
(60) Provisional application No. 60/532,488, filed on Dec. 26, 2003.

(51) Int. Cl. A01K 97/00

(52) U.S. Cl. 43/53.5; 43/5; 294/115; 294/19.3

(57) ABSTRACT

A holder for a fish handling tool includes a base, a jaw engaging member attached to the base and a trigger engaging saddle attached to the base. Another saddle may also be attached to the base.

### RELATED APPLICATIONS

This application claims priority to U.S. Provisional Application 60/532,488, filed Dec. 26, 2003, the entire contents of which are hereby incorporated by reference herein.

### BACKGROUND

1. Field of the Invention

The invention relates to fish handling tools and, more particularly, to a holder for securely holding a fish handling tool.

2. Background Description

Fish handling tools that grip a caught fish by its lower jawbone and include a scale for weighing a fish are known in the art. By way of example and not limitation, such a device is described in U.S. Pat. No. 5,119,585. Various commercially available fish handling tools are well known to avid anglers. Such tools typically include a tubular housing that also serves as a handle and a pair of jaws for gripping a lower lip of a fish. Movement of a longitudinally slidable sleeve, a trigger or a similar mechanical activating device (referred to collectively herein as “triggers”) opens the gripping jaws to grip or release a fish's lower jaw. A mechanical spring scale or an electrical digital scale is built into the housing to weigh a fish suspended by the tool.

A serious problem, however, is that there are no known devices configured for securely mounting and storing such tools in any position. Because such tools are relatively heavy devices, i.e., weighing up to several pounds, a holder must be strong and adapted to securely grip the tool. Existing holders, such as cavity-type which use gravity to hold the device in a tube or eye hooks which are engaged by the gripping jaws of the tool, suffer many shortcomings. For example, they will properly hold the tool only in a certain position. This is particularly problematic because there is limited storage space on boats. Additionally, rocking and bouncing motion can easily dislodge the tool. Not only should the holder securely grip the tool, but it should do so in various positions and even while a boat is traveling at high speeds and impacting the water, and rocking.

Unfortunately, such tools are frequently stored in containers with other tools, in boxes, on eye hooks, or in various compartments on boats. When needed, the tool may be difficult or impossible to locate. Movement of the boat may cause a loosely stored tool to move or fall, further complicating locating the tool when it is needed. A loose tool on the deck of a boat may cause injury. A tool improperly stored on the side of a boat may be lost overboard. As such tools are relatively expensive items, loss can be extremely problematic.

The invention is directed to overcoming one or more of the problems as set forth above.

### SUMMARY OF THE INVENTION

It is an object of the present invention to provide a holder for securely holding a fish handling tool.

The invention solves the problems and/or overcomes the drawbacks and disadvantages of the prior art by providing a holder comprised of a plurality of features for securely engaging one or more parts of a fish handling tool.

### BRIEF DESCRIPTION OF THE DRAWINGS

The foregoing and other objects, features and advantages of the present invention will become better understood with reference to the following description, appended claims, and accompanying drawings, where:

FIG. 1 conceptually provides a perspective view of an exemplary holder with a fish handling tool in accordance with an embodiment of the invention;

FIG. 2 conceptually provides a perspective view of an exemplary holder in accordance with an embodiment of the invention;

FIG. 3 conceptually provides a side view of an exemplary holder in accordance with an embodiment of the invention;

FIG. 4 conceptually shows a cutaway section of an exemplary trigger saddle in accordance with an embodiment of the invention; and

FIG. 5 conceptually shows a cutaway section of an exemplary jaw engaging member in accordance with an embodiment of the invention.

### DETAILED DESCRIPTION OF EMBODIMENTS OF THE INVENTION

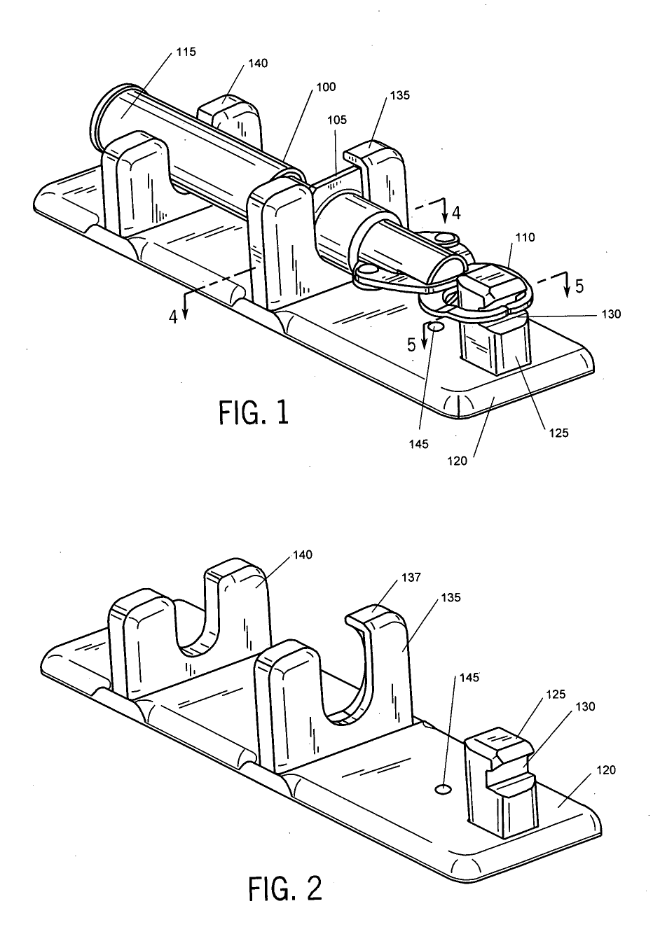

An exemplary embodiment of the invention provides a holder comprised of a plurality of features to securely hold a fish handling tool. In one exemplary embodiment, the features include a handle saddle 140, upon which the handle 115 of a fish handling tool 100 may rest, as shown in FIG. 1. The exemplary handle saddle 140 provides a U-shaped recess having a diameter slightly larger than the diameter of the handle. The handle saddle 140 helps support the tool 100 and aligns it with the other features described below. Thus, the handle saddle 140 provides a means for holding the handle of a fish handling tool 100. Other means for holding the handle of the housing, such as spring clips or brackets with latches, may be used in addition to or in lieu of the handle saddle 140 without departing from the scope of the invention.

The handle saddle 140 is preferably comprised of a corrosion resistant, durable material such as polyvinyl chloride (PVC), polyethylene, polypropylene, polystyrene, acrylics, cellulosics, acrylonitrile-butadiene-styrene terpolymers, urethanes, thermo-plastic resins, thermo-plastic elastomers (TPE), acetal resins, polyamides, polycarbonates and polyesters. Though many other materials may be used alone or in combination with the aforementioned materials and/or other materials, without departing from the scope of the present invention, preferably the material is relatively inexpensive, easy to use in manufacturing operations and results in an aesthetically acceptable product. An exemplary handle saddle 140 is comprised primarily of King Starboard™ (by King Plastic Corporation of Northport, Fla.), a marine grade polymer sheet material, environmentally stabilized to resist harsh sun and sea conditions, including ultraviolet light. The material may further include additives or coatings to provide desired properties such as desired colors, structural characteristics and glow-in-the dark properties.

The handle saddle 140 may be produced using any suitable manufacturing techniques known in the art for the chosen material, such as (for example) mechanically forming a handle saddle 140 using a CNC machine, or by injection, compression, structural foam, blow, or transfer molding; polyurethane foam processing techniques; vacuum forming; or casting. Preferably the manufacturing technique is suitable for mass production at relatively low cost per unit, and results in an aesthetically acceptable product with a consistent acceptable quality.

Those skilled in the art will appreciate that the handle saddle 140 may be formed as one or more separate components, which are then attached to a holder according to the invention. Alternatively, the handle saddle 140 may be formed as an integral part of a holder according to the invention.

In an exemplary embodiment, a holder according to the invention also includes a trigger saddle 135, as shown in FIGS. 1 and 2. Like the handle saddle 140, the trigger saddle 135 is generally a U-shaped recess having a diameter slightly larger than the diameter of the handle. However, the trigger saddle 135 also includes a recess or cavity (or a plurality of recesses or cavities) for receiving the trigger 105 of the tool 100.

Referring to FIG. 4, a cutaway view of Section 4-4 from FIG. 1 is provided to illustrate the recessed area or cavity 138. The trigger 105 rests within the cavity 138 of the trigger saddle 135. Referring again to FIG. 1, a lip or flange portion 137 around all or part of the periphery of the receiving side of the trigger saddle 135 defines the cavity 138.

By receiving the trigger 105, the trigger saddle 135 prevents the tool from falling from the holder, irrespective of how the tool is oriented. Indeed, the trigger saddle 135 prevents motion of the spring biased trigger 105, except backward sliding motion (i.e., motion towards the handle 115 of the tool and away from the jaws 110 of the tool) used to open the jaws 110 of the tool. When the trigger 105 is engaged in the trigger saddle 135, the tool 100 cannot be removed from the holder without sliding the trigger backward and out of the recess 138.

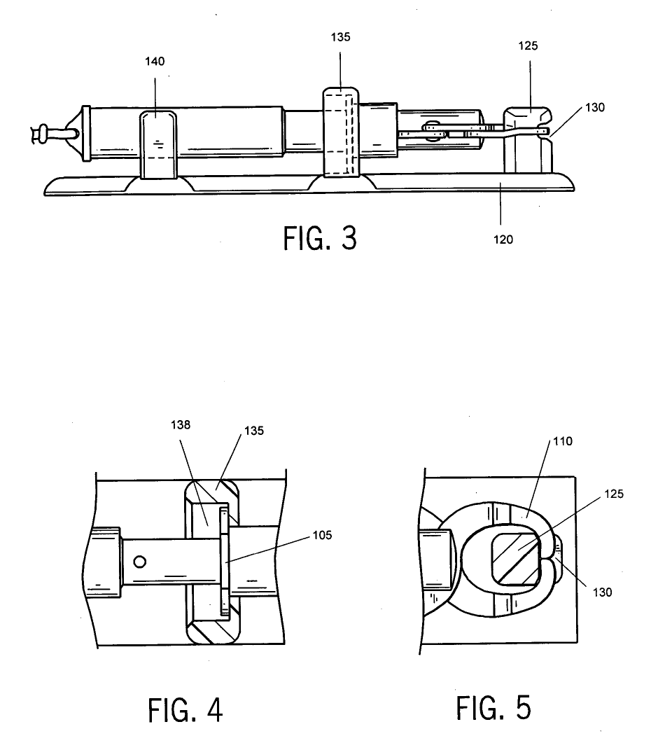

By way of example and not limitation, the trigger saddle 135 shown in FIG. 3 may have a cavity 138 adapted to engage the trigger 105 of a BogaGrip™ fish handling tool by Eastaboga Tackle Manufacturing Co., Inc. of Eastaboga, Ala. Those skilled in the art will appreciate that the configuration of the trigger saddle 135 and its cavity 138 will depend upon the type and configuration of the trigger 105 of the tool 100. The lip or flange portion 137 around all or parts of the periphery of the receiving side of the trigger saddle 135 define a cavity 138 that receives (i.e., receives all or a part of) and is approximately slightly larger than the trigger 105.

The trigger saddle 135 is preferably comprised of a corrosion resistant, durable material such as polyvinyl chloride (PVC), polyethylene, polypropylene, polystyrene, acrylics, cellulosics, acrylonitrile-butadiene-styrene terpolymers, urethanes, thermo-plastic resins, thermo-plastic elastomers (TPE), acetal resins, polyamides, polycarbonates and polyesters. Though many other materials may be used alone or in combination with the aforementioned materials and/or other materials, without departing from the scope of the present invention, preferably the material is relatively inexpensive, easy to use in manufacturing operations and results in an aesthetically acceptable product. An exemplary trigger saddle 135 is comprised primarily of King Starboard™ (by King Plastic Corporation of Northport, Fla.), a marine grade polymer sheet material, environmentally stabilized to resist harsh sun and sea conditions, including ultraviolet light. The material may further include additives or coatings to provide desired properties such as desired colors, structural characteristics and glow-in-the dark properties.

The trigger saddle 135 may be produced using any suitable manufacturing techniques known in the art for the chosen material, such as (for example) mechanically forming a trigger saddle 135 using a CNC machine, or by injection, compression, structural foam, blow, or transfer molding; polyurethane foam processing techniques; vacuum forming; or casting. Preferably the manufacturing techniques are suitable for mass production at relatively low cost per unit, and result in an aesthetically acceptable product with a consistent acceptable quality.

Those skilled in the art will appreciate that the trigger saddle 135 may be formed as one or more separate components, which are then attached to a holder according to the invention. Alternatively, the trigger saddle 135 may be formed as an integral part of a holder according to the invention.

Yet another feature of the exemplary embodiment is a jaw-engaging member 125. In a preferred embodiment, the jaw engaging member includes a notch 130 adapted to receive a portion of the jaws 110 of the tool 100. The jaws 110 of the tool 100 preferably close around the notched area 130 of the jaw engaging member 125. Thus, the engaged (e.g., notched) portion of the jaw engaging member 125 is preferably approximately no larger than the space provided between the closed jaws 110 of the tool. Referring to FIG. 5, cutaway section 5-5 from FIG. 1 is shown, illustrating the notch 130. The notch 130 provides a means for engaging and restricting vertical/horizontal/lateral movement of the engaged jaws 110. Other means for restricting vertical/horizontal/lateral movement of the engaged jaws (e.g., a cap on the free end of the jaw engaging member 125, or protruding collars, flanges or ridges around the periphery of the jaw engaging member 125 and the like) may be used in addition to or in lieu of a notch 130.

The jaw engagement member 125 is preferably comprised of a corrosion resistant, durable material such as polyvinyl chloride (PVC), polyethylene, polypropylene, polystyrene, acrylics, cellulosics, acrylonitrile-butadiene-styrene terpolymers, urethanes, thermo-plastic resins, thermo-plastic elastomers (TPE), acetal resins, polyamides, polycarbonates and polyesters. Though many other materials may be used alone or in combination with the aforementioned materials and/or other materials, without departing from the scope of the present invention, preferably the material is relatively inexpensive, easy to use in manufacturing operations and results in an aesthetically acceptable product. An exemplary jaw engagement member 125 is comprised primarily of King Starboard™ (by King Plastic Corporation of Northport, Fla.), a marine grade polymer sheet material, environmentally stabilized to resist harsh sun and sea conditions, including ultraviolet light. The material may further include additives or coatings to provide desired properties such as desired colors, structural characteristics and glow-in-the dark properties.

The jaw engagement member 125 may be produced using any suitable manufacturing techniques known in the art for the chosen material, such as (for example) mechanically forming a jaw engagement member 125 using a CNC machine, or by injection, compression, structural foam, blow, or transfer molding; polyurethane foam processing techniques; vacuum forming; or casting. Preferably the manufacturing technique is suitable for mass production at relatively low cost per unit, and results in an aesthetically acceptable product with a consistent acceptable quality.

Those skilled in the art will appreciate that the jaw engagement member 125 may be formed as one or more separate components, which are then attached to a holder according to the invention. Alternatively, the jaw engagement member 125 may be formed as an integral part of a holder according to the invention.

The exemplary holder also includes a base 120, as shown in FIGS. 1-3, to which the various features described above (i.e., the handle saddle 140, trigger saddle 135 and jaw engaging member 125) are attached. The features may be mechanically attached, such as by using screws, or chemically attached, such as with glue, cement or other bonding agents. Alternatively, the holder may be fabricated as a unitary, integral component. The base is preferably configured with a flat back for mounting to a flat surface. Preferably, one or more mounting holes, such as 145, are provided for attaching the base to a surface, such as with nails, screws or bolts. However, other means for attaching the base to a surface (e.g., glue) may be used without departing from the scope of the invention, including suction cups.

The base 120 is preferably comprised of a corrosion resistant, durable material such as polyvinyl chloride (PVC), polyethylene, polypropylene, polystyrene, acrylics, cellulosics, acrylonitrile-butadiene-styrene terpolymers, urethanes, thermoplastic resins, thermo-plastic elastomers (TPE), acetal resins, polyamides, polycarbonates and polyesters. Though many other materials may be used alone or in combination with the aforementioned materials and/or other materials, without departing from the scope of the present invention, preferably the material is relatively inexpensive, easy to use in manufacturing operations and results in an aesthetically acceptable product. An exemplary base 120 is comprised primarily of King Starboard™ (by King Plastic Corporation of Northport, Fla.), a marine grade polymer sheet material, environmentally stabilized to resist harsh sun and sea conditions, including ultraviolet light. The material may further include additives or coatings to provide desired properties such as desired colors, structural characteristics and glow-in-the dark properties.

The base 120 may be produced using any suitable manufacturing techniques known in the art for the chosen material, such as (for example) mechanically forming a base 120 using a CNC machine, or by injection, compression, structural foam, blow, or transfer molding; polyurethane foam processing techniques; vacuum forming; or casting. Preferably the manufacturing technique is suitable for mass production at relatively low cost per unit, and results in an aesthetically acceptable product with a consistent acceptable quality.

Those skilled in the art will appreciate that the base 120 may be formed as one or more separate components, which are then attached to other components of a holder according to the invention. Alternatively, the base 120 may be formed as an integral part of a holder according to the invention.

Correct positioning of the various components is important for proper utility of a holder according to the invention. The jaw engaging member 125 should be positioned, relative to the trigger saddle 135, a distance approximately equal to the distance between the trigger 105 of the tool 100 at rest and the opening between the jaws 110 of the tool 100 at rest. The jaw engaging member 125 should be aligned with the trigger saddle 135, which should be aligned with the handle saddle 140.

To store a fish handling tool 100 in a holder according to the invention, the spring biased trigger 105 is forced back opening the jaws 110. The opened jaws may be placed around the jaw engaging member 125 and the handle 115 may be set into the handle saddle 140. When the trigger 105 is released, it will return to its at-rest position, and settle in the cavity or recess 138 defined in the trigger saddle 135. The spring bias keeps the jaws 110 closed and the trigger 105 in its at-rest position.

To remove the fish handling tool 100 from the holder, the trigger 105 is drawn back (i.e., retracted), thus opening the jaws 110. The retracted trigger 105 is disengaged from the trigger saddle 135. The opened jaws 110 may be moved away from the jaw engaging member 125. The handle 115 may be pulled away from the saddle.

Advantageously, the exemplary holder locks the fish handling tool in place without relying upon gravity or a loose cavity. Because the exemplary holder restrains vertical, horizontal and lateral movement, it provides considerable mounting flexibility. A holder according to the invention may be mounted in many positions/orientations, including on a wall vertically with the jaw engaging member positioned up or down, horizontally, with the jaw engaging member to the left or right, at an angle, atop a table, on the side wall of a bulkhead, upside down (e.g., on a ceiling).

While the invention has been described in terms of exemplary embodiments, those skilled in the art will recognize that the invention can be practiced with modifications within the spirit and scope of the foregoing detailed description. Such alternative embodiments and implementations are intended to come within the scope of the present invention.

1. A holder for a fish handling tool having a pair of jaws and a trigger, the holder being comprised of:
a base;
a jaw engaging member attached to the base; and
a trigger saddle attached to the base.

2. A holder according to claim 1, wherein the trigger saddle includes a cavity, said cavity being adapted to receive the trigger of the fish handling tool.

3. A holder according to claim 1, wherein the trigger saddle includes a U-shaped recess.

4. A holder according to claim 1, wherein the distance between the trigger saddle and the jaw engaging member is approximately equal to the distance between a center opening between the pair of jaws and the trigger of the fish handling tool.

5. A holder according to claim 1, wherein the trigger saddle is aligned with the jaw engaging member.

6. A holder according to claim 1, wherein the jaw engaging member includes a notch adapted to engage at least a portion of the pair of jaws.

7. A holder according to claim 1, wherein the jaw engaging member includes means for engaging and restricting vertical and horizontal and lateral movement of the engaged jaws.

8. A holder according to claim 1, wherein the base includes at least one mounting hole.

9. A holder according to claim 1, the holder further being comprised of a handle saddle.

10. A holder according to claim 9, wherein the handle saddle includes a U-shaped recess.

11. A holder according to claim 9, wherein the trigger saddle is disposed between the handle saddle and the jaw engaging member.

12. A holder for a fish handling tool having a pair of jaws and a trigger, the holder being comprised of:
a base;
a handle engaging member attached to the base;
a jaw engaging member attached to the base; and
a trigger saddle attached to the base, the trigger saddle including a cavity, the cavity being adapted to receive the trigger of the fish handling tool.

13. A holder according to claim 12, wherein the trigger saddle includes a U-shaped recess.

14. A holder according to claim 13, wherein the distance between the trigger saddle and the jaw engaging member is approximately equal to the distance between a center opening between the pair of jaws and the trigger of the fish handling tool.

15. A holder according to claim 14, wherein the trigger saddle is aligned with the jaw engaging member.

16. A holder according to claim 15, wherein the jaw engaging member includes means for engaging and restricting vertical and horizontal and lateral movement of the engaged jaws.

17. A holder according to claim 16, wherein the means for engaging and restricting vertical and horizontal and lateral movement of the engaged jaws includes a notch.

18. A holder according to claim 17, wherein the base includes at least one mounting hole.

19. A holder according to claim 18, wherein the handle saddle includes a U-shaped recess.

20. A holder according to claim 19, wherein the trigger saddle is disposed between the handle saddle and the jaw engaging member.
